(19) United States
(12) Patent Application Publication
(10) Pub. No.: US 2024/0037471 A1
(43) Pub. Date: Feb. 1, 2024

(54) BUILDINGS WITH PRIORITIZED SUSTAINABLE INFRASTRUCTURE

(71) Applicant: Johnson Controls Tyco IP Holdings LLP, Milwaukee, WI (US)

(72) Inventors: Joseph C. Jones, Milwaukee, WI (US); Nicole Elyse James, Milwaukee, WI (US); Robbie Glen Davis, Milwaukee, WI (US)

(21) Appl. No.: 18/223,330

(22) Filed: Jul. 18, 2023

Related U.S. Application Data
(60) Provisional application No. 63/390,569, filed on Jul. 19, 2022.

(51) Int. Cl. G06Q 10/0631

(52) U.S. Cl. CPC G06Q 10/06315

(57) ABSTRACT

A method for increasing sustainability of buildings includes obtaining building operational data from a plurality of building management systems and providing scores for a plurality of potential sustainable infrastructure projects by scoring the potential sustainable infrastructure projects based on at least one of utility information, climate data, building characteristics, or the building operational data. The scores can be generated at least in part on the building operational data. The method also includes providing, via a graphical user interface, a ranking of the potential sustainable infrastructure projects based on the scores.

### CROSS-REFERENCE TO RELATED APPLICATION

This application claims the benefit of and priority to U.S. Provisional Patent Application No. 63/390,569 filed Jul. 19, 2022, the entire disclosure of which is incorporated by reference herein.

### BACKGROUND

This application relates to buildings, in particular to sustainable infrastructure for buildings. Operation of building systems, for example heating, ventilation, and/or air conditioning (HVAC) systems, is a major contributor to global energy consumption and thus associated carbon emissions and other pollution or other negative effects of energy consumption. New infrastructure, for example local solar grids or other green energy harvesting equipment, heat pumps, high-efficiency HVAC equipment, high-efficiency lighting devices, electric vehicle charging stations, energy storage systems, improved insulation and windows, etc., can be installed at buildings, including via retrofit of existing buildings, to reduce building consumption and corresponding emissions or other negative environmental effects via sustainable infrastructure projects. However, all such sustainable infrastructure project cannot be feasibly executed simultaneously or immediately, such that a technical challenge exists in providing sustainable infrastructure projects in a manner (e.g., order) that quickly and efficiently achieves the environmental benefits of implementing such projects.

### SUMMARY

Some implementations of the present disclosure include a method for increasing sustainability of buildings. The method includes obtaining building operational data from a plurality of building management systems and providing scores for a plurality of potential sustainable infrastructure projects by scoring the potential sustainable infrastructure projects based on at least one of utility information, climate data, building characteristics, or the building operational data. The scores can be generated at least in part on the building operational data. The method also includes providing, via a graphical user interface, a ranking of the potential sustainable infrastructure projects based on the scores.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to an exemplary embodiment.

FIG. 2 is a block diagram of a building automation system (BAS) that may be used to monitor and/or control the building of FIG. 1, according to an exemplary embodiment.

FIG. 3 is a block diagram of a system for sustainability optimization for planning a building, according to an exemplary embodiment.

FIG. 4 is a block diagram of an energy bill retrieval system of the sustainability optimization system of FIG. 3, the energy bill retrieval system retrieving utility bills for the building, according to an exemplary embodiment.

FIG. 5 is a block diagram of a building audit system of the system of FIG. 3, the facility audit system configured to collect building data of the building via an audit, according to an exemplary embodiment.

FIG. 6 is a block diagram of a demand side data system of the system of FIG. 3, the demand side data system configured to collect building system and operational data from a building and calculate energy metrics, carbon metrics, operational metrics, and facility improvement measures (FIMs) for the building, according to an exemplary embodiment.

FIG. 7 is a block diagram of an on-site supply data system of the system of FIG. 3, the on-site supply system configured to collect data from an on-site energy supply system for the building, according to an exemplary embodiment.

FIG. 8 is a block diagram of a sustainability advisor and an optimization system of the system of FIG. 3, the sustainability advisor configured to provide sustainability data to a user and receive input from the user and the optimization system configured to run sustainability optimizations for the building, according to an exemplary embodiment.

FIG. 9 is a block diagram of a planning tool which can be used to determine the benefits of investing in a battery asset and calculate various financial metrics associated with the investment, according to an exemplary embodiment.

FIG. 10 is a block diagram illustrating the asset sizing module, according to an exemplary embodiment.

FIG. 11 is a flowchart of a process for implementing sustainable infrastruction projects, according to an exemplary embodiment.

### DETAILED DESCRIPTION

Referring generally to the FIGURES, features relating to prioritized sustainable infrastructure are shown, according to some embodiments.

Energy and other resource consumption by building infrastructure (e.g., for heating, cooling, ventilating, lighting, etc. building spaces, for powering appliances, computers, etc. in buildings) accounts for a large percentage of total energy and resource usage by society. Providing buildings with sustainable infrastructure (e.g., on-site green energy generation, microgrids, energy storage, improved materials, optimization technologies, etc.) can help reduce overall energy and resource consumption, reach net zero emissions targets, achieve net zero energy goals, combat climate change, reduce or eliminate dependence on fossil fuels, etc. However, installing sustainable infrastructure can be unequally beneficial for different buildings depending on a variety of factors and the ability to install sustainable infrastructure is limited by a number of physical, technical, and other constraints. The present disclosure relates, in part, to prioritizing sustainable infrastructure for buildings in a manner that, for example, can maximize the technical benefits of reduced energy and resource consumption for collections of buildings, achieve emissions reductions in a high-efficiency (e.g., fastest, most cost-effective, etc.) manner, or otherwise unlock the benefits of sustainable infrastructure in an advantageous way, as is explained in further detail below.

One implementation of the present disclosure is a method of increasing sustainability of buildings. The method includes obtaining building operational data from a plurality of building management systems, providing scores for a plurality of potential sustainable infrastructure projects by scoring the potential sustainable infrastructure projects based on at least one of utility information, climate data, building characteristics, or the building operational data, wherein the scores are generated at least in part on the building operational data, and providing, via a graphical user interface, a ranking of the potential sustainable infrastructure projects based on the scores.

According to some embodiments, systems and methods are provided for sustainability optimization planning a building, according to various exemplary embodiments. A sustainability optimization system can be configured to collect various pieces of information regarding a building, e.g., energy supply data, on-site energy generation systems, demand data, indications of building equipment, etc. The sustainability optimization system can be configured to run an optimization on the collected data to identify improvements for the building that result in sustainable operation of the building. For example, the optimization can optimize for various metrics of the building, e.g., carbon footprint, energy usage, financial cost, etc. The result of the optimization could be to retrofit certain pieces of building equipment, install on-site solar panels, purchase renewable energy credits (RECs), generate a building control plan, etc.

The optimization can, in some embodiments, result in building planning that causes the building to meet a sustainability goal in a particular timeline. For example, the user may have a goal for their building to reach net-zero carbon emissions (or a predefined level of carbon emissions) over the next thirty years. The optimization can run periodically, e.g., every year, to optimize over an optimization period (e.g., the next five years) and to meet the goal over the total planning period (e.g., the next thirty years).

### Building Management System and HVAC System

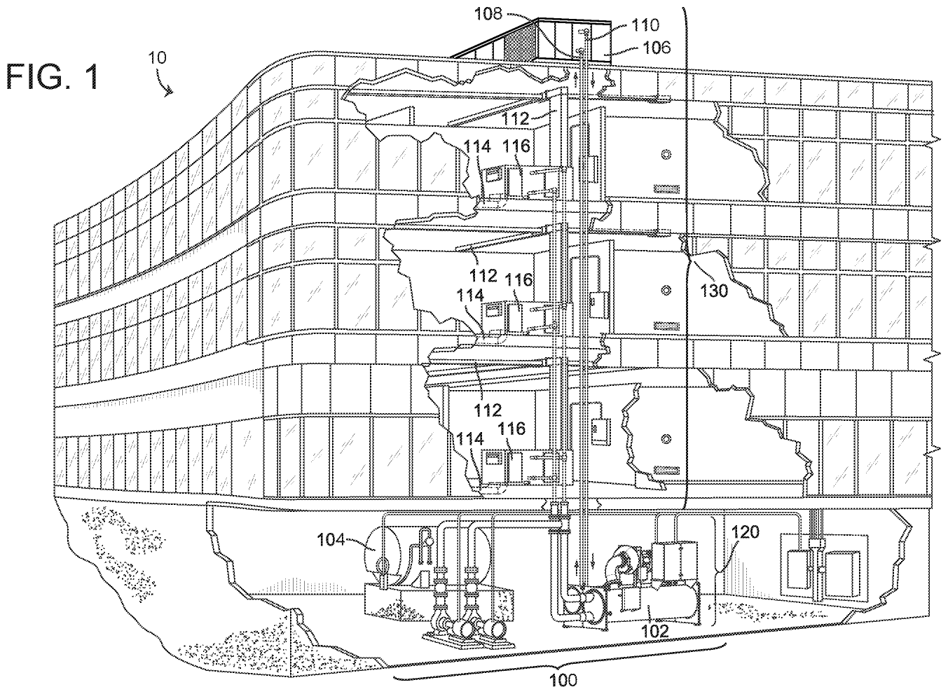

Referring now to FIG. 1, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, and/or any other system that is capable of managing building functions or devices, or any combination thereof.

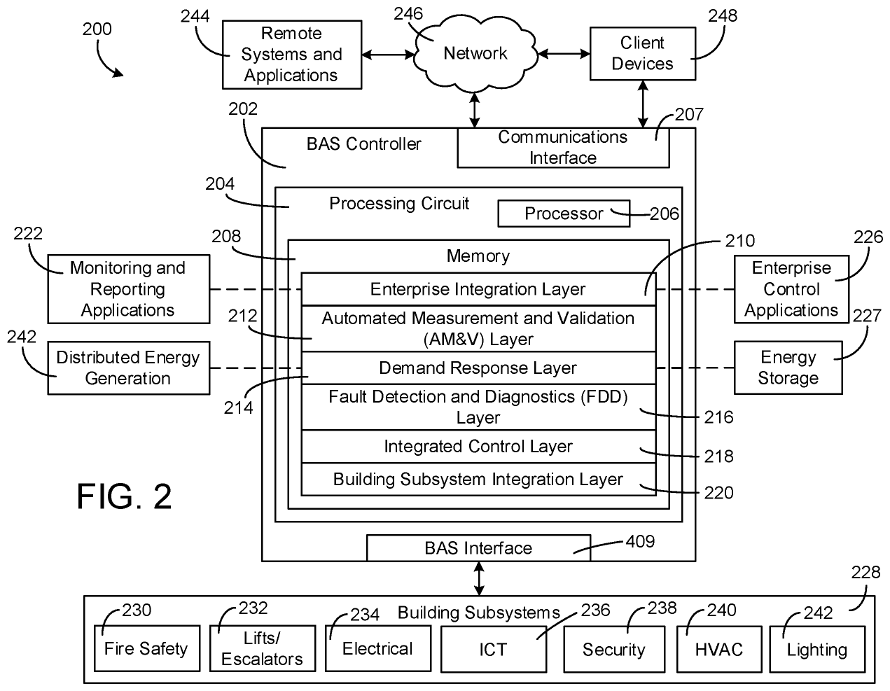

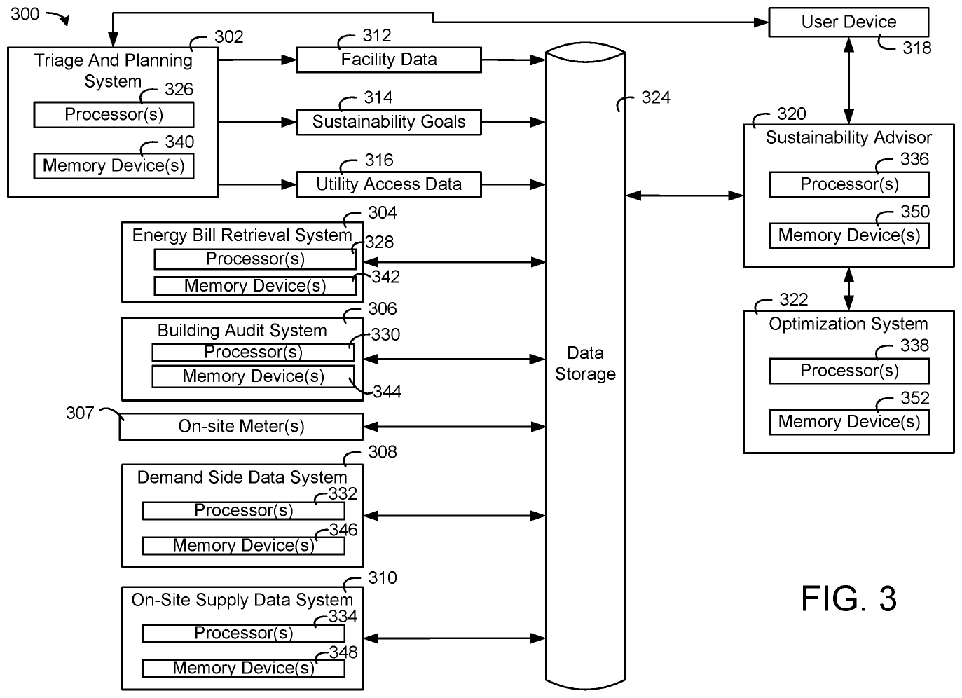

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a building automation system (BAS) 200 is shown, according to an exemplary embodiment. BAS 200 can be implemented in building 10 to automatically monitor and control various building functions. BAS 200 is shown to include BAS controller 202 and building subsystems 228. Building subsystems 228 are shown to include a building electrical subsystem 234, an information communication technology (ICT) subsystem 236, a security subsystem 238, a HVAC subsystem 240, a lighting subsystem 242, a lift/escalators subsystem 232, and a fire safety subsystem 230. In various embodiments, building subsystems 228 can include fewer, additional, or alternative subsystems. For example, building subsystems 228 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 228 include a waterside system and/or an airside system. A waterside system and an airside system are described with further reference to U.S. patent application Ser. No. 15/631,830 filed Jun. 23, 2017, the entirety of which is incorporated by reference herein.

Each of building subsystems 228 can include any number of devices, controllers, and connections for completing its individual functions and control activities. HVAC subsystem 240 can include many of the same components as HVAC system 100, as described with reference to FIG. 1. For example, HVAC subsystem 240 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 242 can include any number of light fixtures, ballasts, lighting sensors, dimmers, or other devices configured to controllably adjust the amount of light provided to a building space. Security subsystem 238 can include occupancy sensors, video surveillance cameras, digital video recorders, video processing servers, intrusion detection devices, access control devices and servers, or other security-related devices.

Still referring to FIG. 2, BAS controller 202 is shown to include a communications interface 207 and a BAS interface 209. Interface 207 can facilitate communications between BAS controller 202 and external applications (e.g., monitoring and reporting applications 222, enterprise control applications 226, remote systems and applications 244, applications residing on client devices 248, etc.) for allowing user control, monitoring, and adjustment to BAS controller 202 and/or subsystems 228. Interface 207 can also facilitate communications between BAS controller 202 and client devices 248. BAS interface 209 can facilitate communications between BAS controller 202 and building subsystems 228 (e.g., HVAC, lighting security, lifts, power distribution, business, etc.).

Interfaces 207, 209 can be or include wired or wireless communications interfaces (e.g., jacks, antennas, transmitters, receivers, transceivers, wire terminals, etc.) for conducting data communications with building subsystems 228 or other external systems or devices. In various embodiments, communications via interfaces 207, 209 can be direct (e.g., local wired or wireless communications) or via a communications network 246 (e.g., a WAN, the Internet, a cellular network, etc.). For example, interfaces 207, 209 can include an Ethernet card and port for sending and receiving data via an Ethernet-based communications link or network. In another example, interfaces 207, 209 can include a Wi-Fi transceiver for communicating via a wireless communications network. In another example, one or both of interfaces 207, 209 can include cellular or mobile phone communications transceivers. In one embodiment, communications interface 207 is a power line communications interface and BAS interface 209 is an Ethernet interface. In other embodiments, both communications interface 207 and BAS interface 209 are Ethernet interfaces or are the same Ethernet interface.

Still referring to FIG. 2, BAS controller 202 is shown to include a processing circuit 204 including a processor 206 and memory 208. Processing circuit 204 can be communicably connected to BAS interface 209 and/or communications interface 207 such that processing circuit 204 and the various components thereof can send and receive data via interfaces 207, 209. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to an exemplary embodiment, memory 208 is communicably connected to processor 206 via processing circuit 204 and includes computer code for executing (e.g., by processing circuit 204 and/or processor 206) one or more processes described herein.

In some embodiments, BAS controller 202 is implemented within a single computer (e.g., one server, one housing, etc.). In various other embodiments BAS controller 202 can be distributed across multiple servers or computers (e.g., that can exist in distributed locations). Further, while FIG. 2 shows applications 222 and 226 as existing outside of BAS controller 202, in some embodiments, applications 222 and 226 can be hosted within BAS controller 202 (e.g., within memory 208).

Still referring to FIG. 2, memory 208 is shown to include an enterprise integration layer 210, an automated measurement and validation (AM&V) layer 212, a demand response (DR) layer 214, a fault detection and diagnostics (FDD) layer 216, an integrated control layer 218, and a building subsystem integration later 220. Layers 210-220 is configured to receive inputs from building subsystems 228 and other data sources, determine optimal control actions for building subsystems 228 based on the inputs, generate control signals based on the optimal control actions, and provide the generated control signals to building subsystems 228 in some embodiments. The following paragraphs describe some of the general functions performed by each of layers 210-220 in BAS 200.

Enterprise integration layer 210 can be configured to serve clients or local applications with information and services to support a variety of enterprise-level applications. For example, enterprise control applications 226 can be configured to provide subsystem-spanning control to a graphical user interface (GUI) or to any number of enterprise-level business applications (e.g., accounting systems, user identification systems, etc.). Enterprise control applications 226 can also or alternatively be configured to provide configuration GUIs for configuring BAS controller 202. In yet other embodiments, enterprise control applications 226 can work with layers 210-220 to optimize building performance (e.g., efficiency, energy use, comfort, or safety) based on inputs received at interface 207 and/or BAS interface 209.

Building subsystem integration layer 220 can be configured to manage communications between BAS controller 202 and building subsystems 228. For example, building subsystem integration layer 220 can receive sensor data and input signals from building subsystems 228 and provide output data and control signals to building subsystems 228. Building subsystem integration layer 220 can also be configured to manage communications between building subsystems 228. Building subsystem integration layer 220 translate communications (e.g., sensor data, input signals, output signals, etc.) across multi-vendor/multi-protocol systems.

Demand response layer 214 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 224, from energy storage 227, or from other sources. Demand response layer 214 can receive inputs from other layers of BAS controller 202 (e.g., building subsystem integration layer 220, integrated control layer 218, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 214 includes control logic for responding to the data and signals it receives. These responses can include communicating with the control algorithms in integrated control layer 218, changing control strategies, changing setpoints, or activating/deactivating building equipment or subsystems in a controlled manner. Demand response layer 214 can also include control logic configured to determine when to utilize stored energy. For example, demand response layer 214 can determine to begin using energy from energy storage 227 just prior to the beginning of a peak use hour.

In some embodiments, demand response layer 214 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 214 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 214 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable setpoint adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 218 can be configured to use the data input or output of building subsystem integration layer 220 and/or demand response later 214 to make control decisions. Due to the subsystem integration provided by building subsystem integration layer 220, integrated control layer 218 can integrate control activities of the subsystems 228 such that the subsystems 228 behave as a single integrated supersystem. In an exemplary embodiment, integrated control layer 218 includes control logic that uses inputs and outputs from building subsystems to provide greater comfort and energy savings relative to the comfort and energy savings that separate subsystems could provide alone. For example, integrated control layer 218 can be configured to use an input from a first subsystem to make an energy-saving control decision for a second subsystem. Results of these decisions can be communicated back to building subsystem integration layer 220.

Integrated control layer 218 is shown to be logically below demand response layer 214. Integrated control layer 218 can be configured to enhance the effectiveness of demand response layer 214 by enabling building subsystems 228 and their respective control loops to be controlled in coordination with demand response layer 214. This configuration can reduce disruptive demand response behavior relative to conventional systems. For example, integrated control layer 218 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 218 can be configured to provide feedback to demand response layer 214 so that demand response layer 214 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 218 is also logically below fault detection and diagnostics layer 216 and automated measurement and validation layer 212. Integrated control layer 218 can be configured to provide calculated inputs (e.g., aggregations) to these higher levels based on outputs from more than one building subsystem.

Automated measurement and validation (AM&V) layer 212 can be configured to verify that control strategies commanded by integrated control layer 218 or demand response layer 214 are working properly (e.g., using data aggregated by AM&V layer 212, integrated control layer 218, building subsystem integration layer 220, FDD layer 216, or otherwise). The calculations made by AM&V layer 212 can be based on building system energy models and/or equipment models for individual BAS devices or subsystems. For example, AM&V layer 212 can compare a model-predicted output with an actual output from building subsystems 228 to determine an accuracy of the model.

Fault detection and diagnostics (FDD) layer 216 can be configured to provide on-going fault detection for building subsystems 228, building subsystem devices (i.e., building equipment), and control algorithms used by demand response layer 214 and integrated control layer 218. FDD layer 216 can receive data inputs from integrated control layer 218, directly from one or more building subsystems or devices, or from another data source. FDD layer 216 can automatically diagnose and respond to detected faults. The responses to detected or diagnosed faults can include providing an alarm message to a user, a maintenance scheduling system, or a control algorithm configured to attempt to repair the fault or to work-around the fault.

FDD layer 216 can be configured to output a specific identification of the faulty component or cause of the fault (e.g., loose damper linkage) using detailed subsystem inputs available at building subsystem integration layer 220. In other exemplary embodiments, FDD layer 216 is configured to provide “fault” events to integrated control layer 218 which executes control strategies and policies in response to the received fault events. According to an exemplary embodiment, FDD layer 216 (or a policy executed by an integrated control engine or business rules engine) can shut-down systems or direct control activities around faulty devices or systems to reduce energy waste, extend equipment life, or assure proper control response.

FDD layer 216 can be configured to store or access a variety of different system data stores (or data points for live data). FDD layer 216 can use some content of the data stores to identify faults at the equipment level (e.g., specific chiller, specific AHU, specific terminal unit, etc.) and other content to identify faults at component or subsystem levels. For example, building subsystems 228 can generate temporal (i.e., time-series) data indicating the performance of BAS 200 and the various components thereof. The data generated by building subsystems 228 can include measured or calculated values that exhibit statistical characteristics and provide information about how the corresponding system or process (e.g., a temperature control process, a flow control process, etc.) is performing in terms of error from its setpoint. These processes can be examined by FDD layer 216 to expose when the system begins to degrade in performance and alarm a user to repair the fault before it becomes more severe.

Referring now to FIG. 3, a system 300 for sustainability optimization for planning a building is shown, according to an exemplary embodiment. The system 300 includes a triage and planning system 302 that is configured to interact with a user, via a user device 318. The system 300 further includes an energy bill retrieval system 304 configured to retrieve energy bills for a building. The system 300 further includes a building audit system 306 configured to collect and aggregate audit data for the building and one or more on-site meter(s) 307. The system 300 further includes a demand side data system 308 configured to collect demand related data from various building subsystems of a building.

Furthermore, the system 300 includes an on-site supply data system 310 configured to collect data regarding on-site supply systems of the building. Furthermore, the system 300 includes a sustainability advisor 320 configured to present sustainability related optimization results to a user via the user device 318. The system 300 includes an optimization system 322 configured to run an optimization that can identify optimal building retrofit decisions, building improvements, and/or operating plans.

The components of the system 300 can, in some embodiments, be run as instructions on one or more processors. The instructions can be stored in various memory devices. The processors can be the processors 326-338 and the memory devices can be the memory devices 340-352. The processors 326-338 can be implemented as a general purpose processor, an application specific integrated circuit (ASIC), one or more field programmable gate arrays (FPGAs), a group of processing components, or other suitable electronic processing components. The memory devices 340-352 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. The memory devices 340-352 can be or include volatile memory and/or non-volatile memory.

The memory devices 340-352 can include object code components, script components, or any other type of information structure for supporting the various activities and information structures described in the present application. According to some embodiments, the memory 406 is communicably connected to the processors 326-338 and can include computer code for executing (e.g., by the processors 326-338) one or more processes of functionality described herein.

The system 300 includes data storage 324. The data storage 324 can be a database, a data warehouse, a data lake, a data lake-house, etc. The data storage 324 can store raw data, aggregated data, annotated data, formatted data, etc. The data storage 324 can act as a repository for all data collected from the triage and planning system 302, the energy bill retrieval system 304, the building audit system 306, the demand side data system 308, the on-site supply data system 310, the sustainability advisor 320, the optimization system 322, and/or any other system. In some embodiments, the data storage 324 can, in some embodiments, be a digital twin. The digital twin can, in some embodiments, be a graph data structure. The digital twin can be the digital twin described with reference to U.S. patent application Ser. No. 17/134,664 filed Dec. 28, 2020.

The system is shown as including on-site meters 307. The on-site meters 307 can be implemented as physical meters located at a building site and coupled to building electricity systems and/or other resource infrastructure (e.g., natural gas supply line, water supply line, etc.), in a manner adapted to meter resource consumption of a building. In some embodiments, multiple on-site meters 307 are arranged to measure consumption of different equipment units, subsystems, or the like to provide consumption data for different equipment units, subsystems, etc. Such direct measurement of consumption can be provided to data storage 324 or other systems herein for use in the various operations disclosed herein.

The triage and planning system 302 can provide one or more user interfaces to a user via the user device 318. The user interfaces can allow the user to interact and provide various pieces of information describing a building while the building is in a design phase and/or for an onboarding phase where a user first registers with the system 300 to begin sustainability planning for their building. The triage and planning system 302 can receive facility data 312, sustainability goals 314, and/or utility access data 316. The facility data 312 can describe a building facility, e.g., provide a name of the facility or campus, identify a number of buildings in the facility or campus, identify a use of each building, include a name of each building, indicate campus layout, indicate building size, indicate building square footage, indicate campus square footage, indicate geographic location, etc.

The triage and planning system 302 can receive sustainability goals 314 from the user devices 318. The sustainability goals 314 can be customer goals for their building with respect to energy reduction, carbon creation, carbon footprint, water usage reduction, switching to renewable energy, purchasing a certain number of renewable energy credits, etc. The goals can include target levels for energy consumption, carbon production, net zero carbon emissions, renewable energy, etc. The goals can further include timelines for the various target levels. For example, the timeline could be a period of time into the future, e.g., a number of days, weeks, months, years, decades, etc. The timeline can indicate a target date. For example, the timeline could be that a building is energy independent in the next forty years, or that the building is at a net-zero carbon emissions level in the next twenty five years. In some embodiments, the timelines for the sustainability goals can be returned to the user via the user device 318 with recommendations for meeting certain goals, e.g., a recommendation could be to extend a recommendation by five years (e.g., to 25 year) to hit a certain carbon emissions level which would be more financially feasible than attempting to meet the carbon emissions level in 20 years.

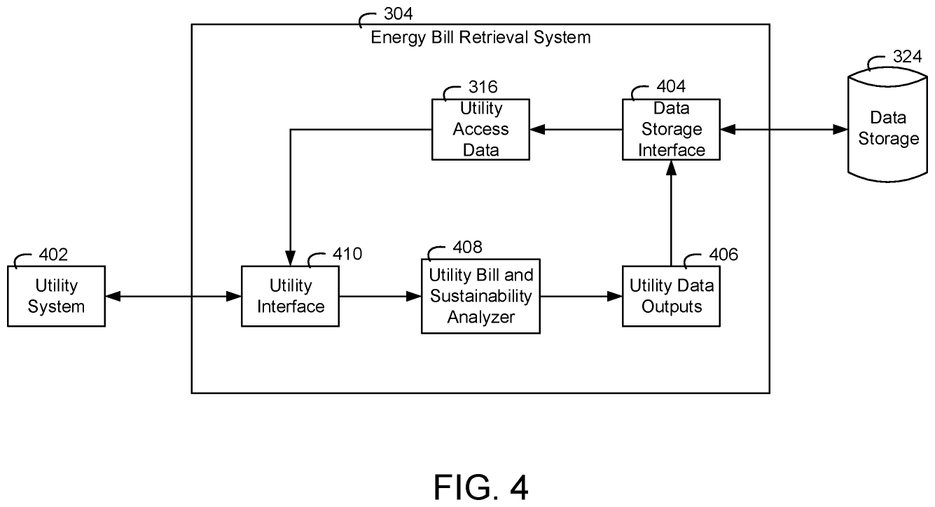

Referring now to FIG. 4, energy bill retrieval system 304 of the sustainability optimization system 300, the energy bill retrieval system retrieves utility bills for the building, according to an exemplary embodiment. The energy bill retrieval system 304 can be configured to retrieve utility access data 316 from the data storage 324 via a data storage interface 404. The bills can be electric bills, natural gas bills, water bills, etc. The data storage interface 404 can be an interface that integrates with the data storage 324 via an application programming interface (API) or otherwise exposes and API to external systems. A utility interface 410 can receive the utility access data 316 and retrieve utility bills from a utility system 402 based on the utility access data 316. The utility access data 316 can include a username, a login credential, an email address, an access code, an account number, a name of the energy provider, etc.

A utility interface 410 can, in some embodiments, integrate with the utility system 402 via the utility access data 316. The utility bills can include electricity consumption, water consumption, gas consumption, solar power electric consumption, wind turbine electric consumption, The utility interface 410 can provide the energy bills to a utility bill and sustainability analyzer 408. The analyzer 408 can run various analytics on the utility bills.

For example, the analyzer 408 could identify invoice data, perform an audit on utility bill data, and/or perform an analysis on energy rates and/or tariffs for the energy (e.g., environmental penalties for various forms of energy). The analyzer 408 can identify an energy consumption baseline for the building, identify benchmarking for the building (e.g., compare the baseline of the building to other peer buildings or an industry to determine a benchmark index), determine facility key performance indicators (KPIs), etc.

The analyzer 408 can identify sustainability data, for example, a carbon emissions baseline for the building (e.g., carbon emissions produced from natural gas or carbon emissions from electricity consumption), sustainability benchmarking (e.g., a peer comparison of the emissions baseline for the building against other buildings), renewable energy usage tracking, etc. The analyzer 408 can generate sustainability reports (e.g., an indication between a baseline emissions and a current emissions to show sustainability tracking), management and verification (M&V) reports, etc. The results of the analysis performed by the analyzer 408 can be the utility data outputs 406 which can be stored in the data storage 324 by the data storage interface 404. In some embodiments, the M&V reporting could illustrate savings between a baseline and an improvement for the building. For example, the M&V reporting could indicate a carbon emissions reduction that results (compared to a baseline) from a particular FIM.

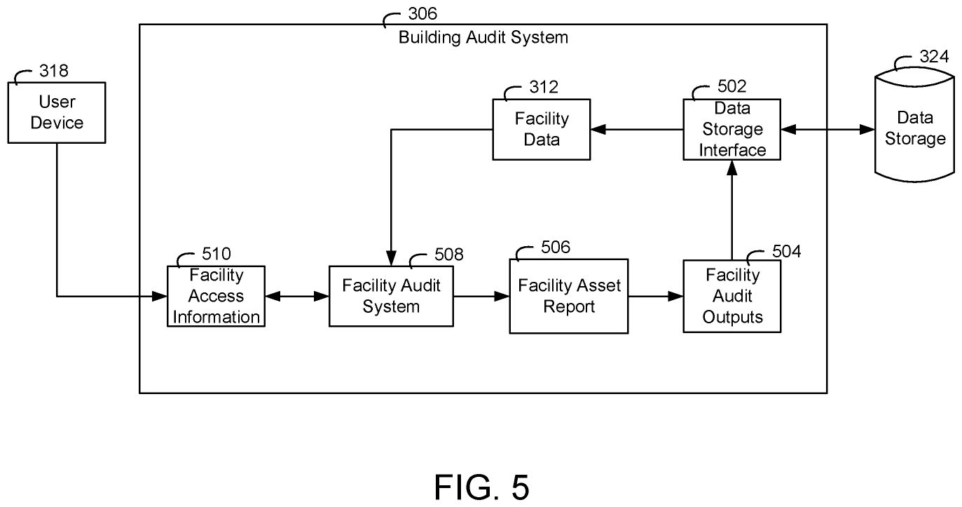

Referring now to FIG. 5, the building audit system 306 of the system 300 is shown, the facility audit system 306 is configured to collect building data of the building via an audit, according to an exemplary embodiment. The building audit system 306 includes a data storage interface 502 that can be the same as, or similar to the data storage interface 404. The interface 504 can retrieve the facility data 312 from the data storage 324. The facility data 312 can be provided to a facility audit system 508. Furthermore, a user, via the user device 318, can provide facility access information 510 (e.g., key codes, registration details, access directions, etc.) to the facility audit system 508. The facility audit system 508 can receive audit details from audit personnel who visit the physical building and record information regarding the building.

Based on the audit data collected by the audit personnel and provided to facility audit system 508, the facility audit system 508 can compile a facility asset report 506. The facility asset report can include information such as a detailed facility description. The facility description can identify each room, zone, and/or floor of a building and indicate the square footage and/or ceiling height of each area of the building. The report 506 can include an equipment inventory. The equipment inventory can indicate the number, make, model, etc. of each piece of equipment in the building. For example, the number and type of chillers in the building could be indicated in the report 506. Furthermore, a maintenance log of all maintenance operations of equipment inventory can be included in the report 506. Furthermore, the report 506 could include photos of all pieces of equipment of the building. The report 506 could further include building envelop information. The result of all the audit outputs of the system 508, including the facility asset report 506, can be stored in the data storage 324 by the data storage interface 502.

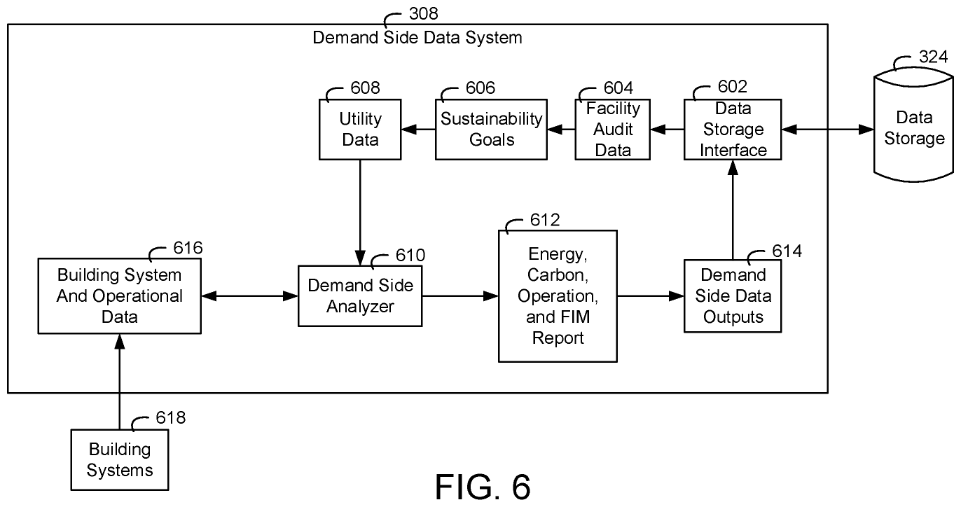

Referring now to FIG. 6, a demand side data system 308 of the system 300, the demand side data system configured to collect building system and operational data from a building and calculate energy metrics, carbon metrics, operational metrics, and facility improvement measures (FIMs) for the building, according to an exemplary embodiment. The system 308 can retrieve facility audit data 604, sustainability goals 606, and/or utility data 608 from the data storage 324 via the data storage interface 602. The data storage interface 602 can be the same as, or similar to, the data storage interface 404. A demand side analyzer 610 can receive the data 602-608. Furthermore, the demand side analyzer 610 can receive building system and/or operational data 616 from the building systems 618. The building system and/or operational data 616 could be metadata for building systems, operating settings for the building systems, runtime data for the building systems, energy usage for the building systems 618, etc. The building systems 618 can be fire safety systems, environmental cooling systems, environmental heating systems, ventilation systems, lighting systems, etc. The building systems 618 can be the systems described with reference to FIGS. 1 and 2.

The demand side analyzer 610 can run an analysis based on the demand related data 602-608 and the building system and/or operational data 616. The analyzer 610 can generate the report 612. The report 612 can indicate an energy breakdown and/or carbon breakdown for demand related systems of the building, e.g., systems that consume energy. The report 612 can indicate an energy consumption level and/or a carbon emissions level for cooling systems of a building, heating systems of a building, lighting systems of the building, etc. The energy consumption level and/or carbon emission level can attribute a portion (e.g., a percentage) of total building energy consumption and/or carbon emissions to specific pieces of equipment, equipment subsystems, subsystem types, building operation modes (heating or cooling), etc.

The analyzer 610 can further identify facility improvement measures (FIMs) for improving and/or reducing energy usage and/or carbon emissions of the building. The FIMs could be replacing a boiler with a newer energy efficient boiler which would result in a particular reduction in energy consumption and/or carbon emission. Furthermore, the analyzer 610 can identify operational improvements, e.g., reducing a temperature setpoint by one degree Fahrenheit during heating over a particular time period to result in a particular energy reduction and/or carbon emissions production. The report 612 can include savings reports. The report 612 can be provided as a demand side data outputs 614 to the interface 602. The interface 602 can store the outputs 614 in the data storage 324. In some embodiments, if the demand side data system 308 is unable to pull data from the building systems 618, the building audit system 306 retrieves the data (e.g., via manual reporting, such as from a building manager, or via other methods).

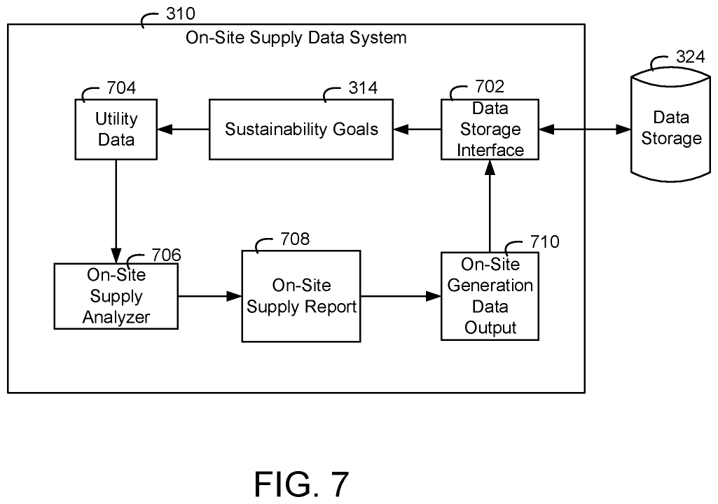

Referring now to FIG. 7, the on-site supply data system 310 is shown, the on-site supply data system 310 is configured to collect data regarding an on-site energy supply system for the building, according to an exemplary embodiment. The on-site supply data system 310 can include a data storage interface 702 configured to retrieve data from the data storage 324, e.g., the sustainability goals 314 and/or utility data 704 determined by the system 304. The interface 702 can be similar to or the same as the interface 404 described with reference to FIG. 4.

An on-site supply analyzer 706 can analyze the utility data 704 and/or the sustainability goals 314 to determine an on-site supply report 708 that can be stored as on-site generation data output 710 in the data storage 324 by the interface 702. The analyzer 706 can analyze the utility data 704 and/or the sustainability goals 314 to identify opportunities to reduce energy usage and/or carbon emissions through on-site energy supply systems, e.g., solar panels, wind power, hydro-electric dams, re-chargeable batteries, etc. The analyzer 708 can identify opportunities to shift power consumption from an energy grid to an on-site energy supply system.

The report 708 can include the results of an analysis on solar photovoltatic (PV) cells, fuel cells, energy storage, etc. The report 708 can further indicate a renewable energy report, e.g., reports on opportunities to shift energy consumption of the building to renewable energy sources that are on-site. The report 708 can further indicate cost savings for energy, e.g., if solar PV cells were installed in a building, how much financial savings in energy cost would result. Furthermore, the report 708 can indicate sustainability data, e.g., how much carbon savings or carbon production would result from consuming various amounts of energy from on-site PV cells, on-site wind turbines, etc.

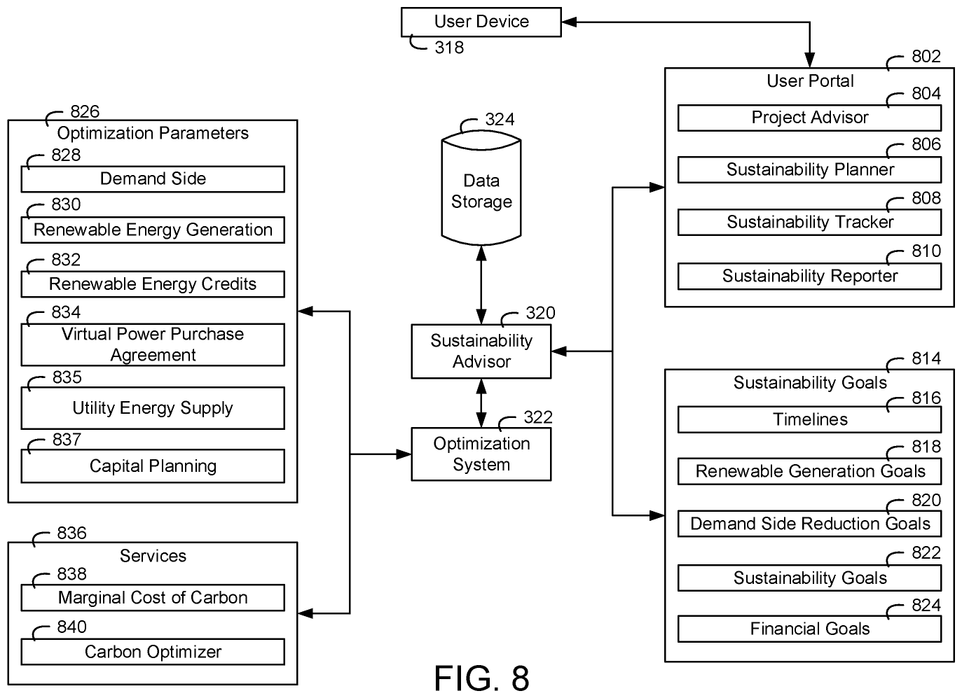

Referring now to FIG. 8, the sustainability advisor 320 and the optimization system 322 are shown, the sustainability advisor 320 is configured to provide sustainability data to a user and receive input from the user and the optimization system 322 is configured to run sustainability optimizations for the building, according to an exemplary embodiment. The sustainability advisor 320 is configured to retrieve data from the data storage 324 (e.g., the data described with reference to FIGS. 3-7) and cause the optimization system 322 to run optimizations based on the data. The sustainability advisor 320 can be configured to manage a user portal 802 which can provide various pieces of information to a user and receive input from the user.

The user portal 802 can interact with a user by causing the user device 318 to display various user interfaces with information regarding cost improvements, energy reduction improvements, and/or carbon emissions reduction improvements for the building. The information displayed in the user portal 802 can be based on the results of the optimizations run by the optimization system 322. The portal 802 can provide various reports and/or recommendations to the user (e.g., recommended FIMs, recommendations to purchase renewable energy credits (RECs), recommendations to adopt updated control strategies, etc.) for planning the construction, retrofit, and/or operation of a building to meet one or more sustainability goals.

The project advisor 804 can allow a user to review, define, and/or update a project. The project may be to plan sustainability for a particular building and/or building. The advisor 804 can allow a user to set and/or update their sustainability goals. Furthermore, the advisor 804 can allow a user to review their progress in meeting the sustainability goals for their project.

The sustainability planner 806 can provide a plan for meeting sustainability goals for a particular project. The plan generated by the sustainability planner 806 can be based on the optimizations run by the optimization system 322. In some embodiments, the plan generated by the sustainability planner 806 can be a plan for a time horizon, e.g., a thirty year plan, a twenty year plan, etc. The plan can provide the steps for meeting the sustainability goal of the user. The steps can indicate what equipment retrofits should be performed at a present time or at a specified time in the future, how many RECs should be purchased every year or every decade, what control schemes should be adopted, etc. As time passes, the sustainability planner 806 can update the sustainability plan based on new optimizations run by the optimization system 322. This can keep the plan on track to meet a goal as the environment or technology changes and allows the user to meet their goals in more cost effective manners. The planner 806 can generate plans based on the sustainability planning data 814.

The sustainability tracker 808 can track the progress of the building towards meeting various sustainability goals. The sustainability tracker 808 can, in some embodiments, retrieve operational building data from the data storage 324, energy bills from the data storage 324, receipts of REC purchases from the data storage 324, etc. The sustainability tracker 808 can identify carbon emissions levels for a building at various times in the past and/or at the present. The sustainability tracker 808 can identify a level of renewable energy consumed by the building at times in the past and/or at the present. Furthermore, the sustainability tracker 808 can identify a level of energy consumed by the building at times in the past and/or at the present. The sustainability tracker 808 can provide a user with a historical trend of the sustainability progress of the building towards the one or more sustainability goals.

The user portal 802 includes a sustainability reporter 810. The sustainability report generator 804 can generate various reports indicating sustainability information for the building. The report can indicate a construction plan, retrofit plan, and/or operational plan for a building, e.g., the amounts of energy to consume from various different energy sources, indications of RECs to purchase, indications of equipment retrofits, indications of physical building retrofits (e.g., energy efficient windows, energy efficient insulation, etc.), indications of new equipment installation (e.g., on-site PV cells, on-site wind turbines, etc.). The report generated by the generator 804 can indicate how the plan meets one or more sustainability, energy efficiency, and/or financial goals of the user. The reporter 810 can include a summary report of sustainability planning for the building. The reporter 810 can compile a report based on the data generated by the components 804-808.

The sustainability planning data 814 includes the planning data that can be used to run the optimization system 322. The planning data 814 can indicate the various goals and/or expectations of the user. The optimization run by the optimization system 322 can use the planning data 814 as constraints for an optimization, e.g., run an optimization that results in a plan that meets or exceeds the various goals and/or expectations. In some embodiments, the optimization can find a sustainability plan for the building that meets the various sustainability goals of the user at a minimum financial cost.

The sustainability planning data 814 can be or can be based on the sustainability goals 314. The timelines 816 can indicate the length of time that the user wants the building to meet various goals (e.g., the goals 818-824). The renewable generation goals 818 indicate a level of energy consumption by the building that the user wants to be generated from renewable energy sources (e.g., solar, wind, etc.). The demand side reduction goals 820 can indicate goals for the demand side systems, e.g., that the demand side systems be energy efficient (e.g., that lighting systems of the building include energy efficient light bulbs). The sustainability goals 822 can be a goal that the operation of the building creates a level of carbon emission, net zero emissions goals, etc. The financial goals 824 can indicate financial goals of the building, e.g., annual energy costs, monthly energy costs, etc.

The optimization parameters 826 include demand side parameters 828 related to the energy demand of a building. The demand side parameters 828 can indicate different types of building equipment retrofits, building equipment maintenance operations, new building equipment installation, building equipment replacement, etc. The demand side parameters 828 can indicate actions that can be taken to modify, change, and/or update the demand side equipment of the building. The parameters 828 can further be linked to renewable energy generation, carbon emissions, energy usage, etc.

The renewable energy generation 830 can indicate parameters for installing renewable energy generation equipment at the building. The parameters 830 can further indicate allocations of energy consumption between external power generation systems, e.g., coal power, hydroelectric power, PV cell systems, wind power systems, etc. The parameters 830 can be linked to various levels of carbon emissions, financial cost, etc.

The parameters 826 include renewable energy credits 832. The renewable energy credits 832 can be various different types of RECs that could be purchased for the building. The parameters can indicate carbon emissions reduction resulting from purchasing RECs and/or financial return from RECs sold by the building. For example, if the building includes on-site renewable energy generation, the building could sell RECs, in some embodiments. Furthermore, the parameters 826 include a virtual power purchase agreement 834 which can represent an agreed price for renewable energy generation. The parameters can further indicate capital planning 837, e.g., plans for replacing, purchasing, and/or repairing capital of the building (e.g., lighting of the building, conference rooms of the building, audio visual systems, insulation of the building, chillers for the building, AHUs for the building, etc.)

The optimization system 322 can include model services 836. The services 836 can include a marginal cost of carbon 838. The marginal cost of carbon 838 can indicate how much carbon emissions results from the next amount of energy consumed by the building. The marginal cost of carbon can be calculated for external utility services and/or on-site energy generation systems of the building. The marginal cost of carbon can be identified from the various energy bills and/or operational decisions of the building. The marginal cost of carbon can, in some embodiments, be based on the optimization parameters 826. The carbon optimizer 840 can run an optimization that identifies decisions for the parameters 826 that results in a particular carbon emissions level. The optimization can be run for a year, five years, ten years into the future, tec. The optimization can be run to slowly reduce the carbon emissions by a particular level every year so that a particular carbon emissions goal is met in the future. The optimization can be run based on the sustainability goals 814 such that the decisions for the parameters 826 are such that the goals 814 are met.

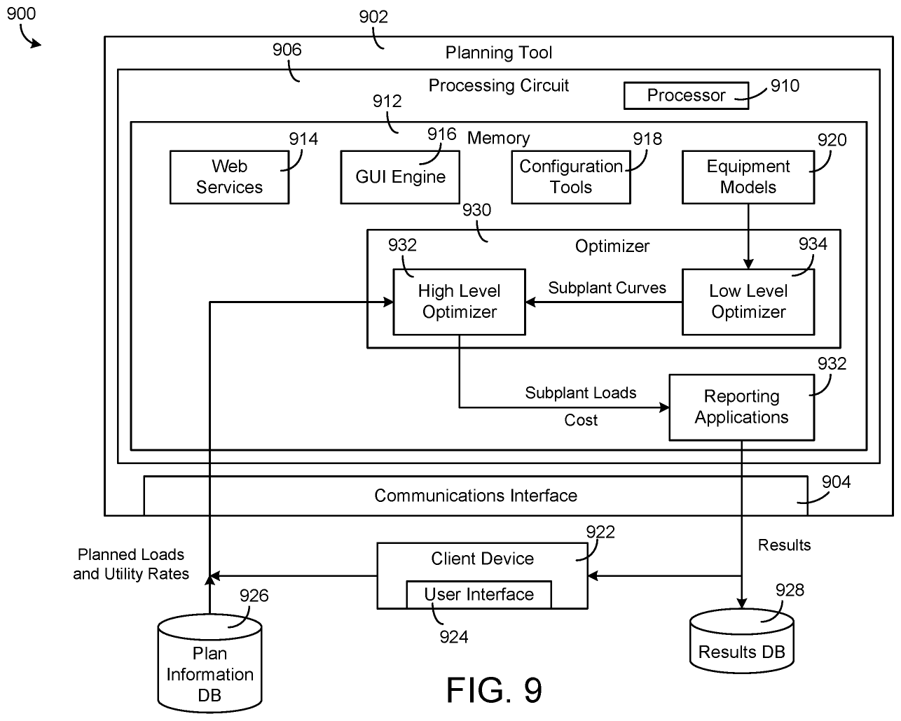

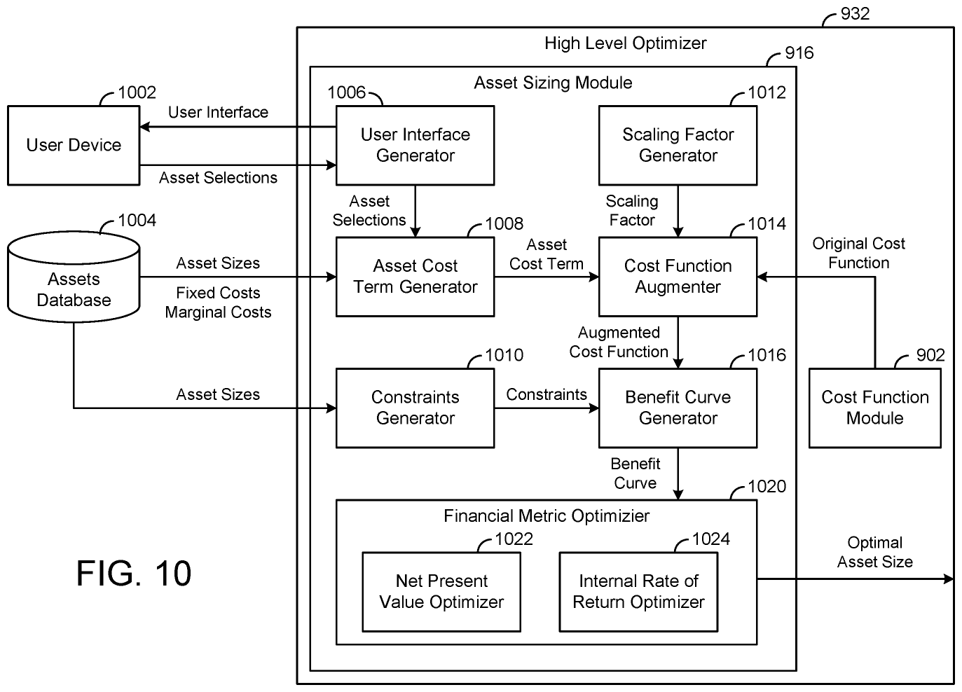

In some embodiments, the optimization run by the optimization system 322 can be based on the optimization described in FIGS. 9 and 10. The optimization can be run with the various linear programming techniques described in FIGS. 9 and 10. Furthermore, the optimization of the optimization system 322 can be based on, and/or can utilize, the techniques described in U.S. patent application Ser. No. 16/518,314 filed Jul. 22, 2019, the entirety of which is incorporated by reference herein.

Referring now to FIG. 9, a block diagram of a planning system 900 is shown, according to an exemplary embodiment. Planning system 900 may be configured to use optimizer 930 as part of a planning tool 902 to simulate the operation of a central plant over a predetermined time period (e.g., a day, a month, a week, a year, etc.) for planning, budgeting, and/or design considerations. The optimizer 930 can optimize for planning a building, e.g., identify construction decisions, retrofit decisions, control plans, etc. The optimizer 930 can run an optimization to minimize carbon emissions, minimize energy consumption, minimize energy cost, maximize renewable energy use, etc. In some embodiments, the optimizer 930 can consider building load in addition to sustainability related features. For example, optimizer 930 may use building loads and utility rates to determine an optimal resource allocation to minimize cost over a simulation period. However, planning tool 902 may not be responsible for real-time control of a building management system or central plant, in some embodiments, while in other embodiments planning tool 902 may provide real-time or near real-time control of a building management system or portions thereof to help achieve the particular goals. In some implementations, planning tool 902 may provide actionable insights or suggestions that, upon approval by a user, are automatically implemented by the building management system or automatically generate changes to a building plan (e.g., pre-construction building plan).

Planning tool 902 can be configured to determine the benefits of investing in a battery asset and the financial metrics associated with the investment. Such financial metrics can include, for example, the internal rate of return (IRR), net present value (NPV), and/or simple payback period (SPP). Planning tool 902 can also assist a user in determining the size of the battery which yields optimal financial metrics such as maximum NPV or a minimum SPP. In some embodiments, planning tool 902 allows a user to specify a battery size and automatically determines the benefits of the battery asset from participating in selected IBDR programs while performing PBDR. In some embodiments, planning tool 902 is configured to determine the battery size that minimizes SPP given the IBDR programs selected and the requirement of performing PBDR. In some embodiments, planning tool 902 is configured to determine the battery size that maximizes NPV given the IBDR programs selected and the requirement of performing PBDR.

In planning tool 902, high level optimizer 932 may receive planned loads and utility rates for the entire simulation period. The planned loads and utility rates may be defined by input received from a user via a client device 922 (e.g., user-defined, user selected, etc.) and/or retrieved from a plan information database 926. High level optimizer 932 uses the planned loads and utility rates in conjunction with subplant curves from low level optimizer 934 to determine an optimal resource allocation (i.e., an optimal dispatch schedule) for a portion of the simulation period. The low level optimizer 934 can receive equipment models 920, in some embodiments.

The portion of the simulation period over which high level optimizer 932 optimizes the resource allocation may be defined by a prediction window ending at a time horizon. With each iteration of the optimization, the prediction window is shifted forward and the portion of the dispatch schedule no longer in the prediction window is accepted (e.g., stored or output as results of the simulation). Load and rate predictions may be predefined for the entire simulation and may not be subject to adjustments in each iteration. However, shifting the prediction window forward in time may introduce additional plan information (e.g., planned loads and/or utility rates) for the newly-added time slice at the end of the prediction window. The new plan information may not have a significant effect on the optimal dispatch schedule since only a small portion of the prediction window changes with each iteration.

In some embodiments, high level optimizer 932 requests all of the subplant curves used in the simulation from low level optimizer 934 at the beginning of the simulation. Since the planned loads and environmental conditions are known for the entire simulation period, high level optimizer 932 may retrieve all of the relevant subplant curves at the beginning of the simulation. In some embodiments, low level optimizer 934 generates functions that map subplant production to equipment level production and resource use when the subplant curves are provided to high level optimizer 932. These subplant to equipment functions may be used to calculate the individual equipment production and resource use (e.g., in a post-processing module) based on the results of the simulation.

Still referring to FIG. 9, planning tool 902 is shown to include a communications interface 904 and a processing circuit 906. Communications interface 904 may include wired or wireless interfaces (e.g., jacks, antennas, transmitters, receivers, transceivers, wire terminals, etc.) for conducting data communications with various systems, devices, or networks. For example, communications interface 904 may include an Ethernet card and port for sending and receiving data via an Ethernet-based communications network and/or a WiFi transceiver for communicating via a wireless communications network. Communications interface 904 may be configured to communicate via local area networks or wide area networks (e.g., the Internet, a building WAN, etc.) and may use a variety of communications protocols (e.g., BACnet, IP, LON, etc.).

Communications interface 904 may be a network interface configured to facilitate electronic data communications between planning tool 902 and various external systems or devices (e.g., client device 922, results database 928, plan information database 926, etc.). For example, planning tool 902 may receive planned loads and utility rates from client device 922 and/or plan information database 926 via communications interface 904. Planning tool 902 may use communications interface 904 to output results of the simulation to client device 922 and/or to store the results in results database 928.

Still referring to FIG. 9, processing circuit 906 is shown to include a processor 910 and memory 912. Processor 910 may be a general purpose or specific purpose processor, an application specific integrated circuit (ASIC), one or more field programmable gate arrays (FPGAs), a group of processing components, or other suitable processing components. Processor 910 may be configured to execute computer code or instructions stored in memory 912 or received from other computer readable media (e.g., CDROM, network storage, a remote server, etc.).

Memory 912 may include one or more devices (e.g., memory units, memory devices, storage devices, etc.) for storing data and/or computer code for completing and/or facilitating the various processes described in the present disclosure. Memory 912 may include random access memory (RAM), read-only memory (ROM), hard drive storage, temporary storage, non-volatile memory, flash memory, optical memory, or any other suitable memory for storing software objects and/or computer instructions. Memory 912 may include database components, object code components, script components, or any other type of information structure for supporting the various activities and information structures described in the present disclosure. Memory 912 may be communicably connected to processor 910 via processing circuit 906 and may include computer code for executing (e.g., by processor 910) one or more processes described herein.

Still referring to FIG. 9, memory 912 is shown to include a GUI engine 916, web services 914, and configuration tools 918. In an exemplary embodiment, GUI engine 916 includes a graphical user interface component configured to provide graphical user interfaces to a user for selecting or defining plan information for the simulation (e.g., planned loads, utility rates, environmental conditions, etc.). Web services 914 may allow a user to interact with planning tool 902 via a web portal and/or from a remote system or device (e.g., an enterprise control application).

Configuration tools 918 can allow a user to define (e.g., via graphical user interfaces, via prompt-driven “wizards,” etc.) various parameters of the simulation such as the number and type of subplants, the devices within each subplant, the subplant curves, device-specific efficiency curves, the duration of the simulation, the duration of the prediction window, the duration of each time step, and/or various other types of plan information related to the simulation. Configuration tools 918 can present user interfaces for building the simulation. The user interfaces may allow users to define simulation parameters graphically. In some embodiments, the user interfaces allow a user to select a pre-stored or pre-constructed simulated plant and/or plan information (e.g., from plan information database 926) and adapt it or enable it for use in the simulation.

Still referring to FIG. 9, memory 912 is shown to include optimizer 930. Optimizer 930 may use the planned loads and utility rates to determine an optimal resource allocation over a prediction window. With each iteration of the optimization process, optimizer 930 may shift the prediction window forward and apply the optimal resource allocation for the portion of the simulation period no longer in the prediction window. Optimizer 930 may use the new plan information at the end of the prediction window to perform the next iteration of the optimization process. Optimizer 930 may output the applied resource allocation to reporting applications 932 for presentation to a client device 922 (e.g., via user interface 924) or storage in results database 928.

Still referring to FIG. 9, memory 912 is shown to include reporting applications 932. Reporting applications 932 may receive the optimized resource allocations from optimizer 930 and, in some embodiments, costs associated with the optimized resource allocations. Reporting applications 932 may include a web-based reporting application with several graphical user interface (GUI) elements (e.g., widgets, dashboard controls, windows, etc.) for displaying key performance indicators (KPI) or other information to users of a GUI. In addition, the GUI elements may summarize relative energy use and intensity across various plants, subplants, or the like. Other GUI elements or reports may be generated and shown based on available data that allow users to assess the results of the simulation. The user interface or report (or underlying data engine) may be configured to aggregate and categorize resource allocation and the costs associated therewith and provide the results to a user via a GUI. The GUI elements may include charts or histograms that allow the user to visually analyze the results of the simulation.

Referring now to FIG. 10, a block diagram illustrating asset sizing module 916 in greater detail is shown, according to an exemplary embodiment. Asset sizing module 916 can be configured to determine the optimal sizes of various assets in a building, group of buildings, or a central plant. As described above, assets can include individual pieces of equipment (e.g., boilers, chillers, heat recovery chillers, steam generators, electrical generators, thermal energy storage tanks, batteries, etc.), groups of equipment, or entire subplants of a central plant. Asset sizes can include a maximum loading of the asset (e.g., maximum power, maximum charge/discharge rate) and/or a maximum capacity of the asset (e.g., maximum stored electric energy, maximum fluid storage, etc.).

In some embodiments, asset sizing module 916 includes a user interface generator 1006. User interface generator 1006 can be configured to generate a user interface for interacting with asset sizing module 916. The user interface may be provided to a user device 1002 (e.g., a computer workstation, a laptop, a tablet, a smartphone, etc.) and presented via a local display of user device 1002. In some embodiments, the user interface prompts a user to select one or more assets or types of assets to be sized. The selected assets can include assets currently in a building or central plant (e.g., existing assets the user is considering upgrading or replacing) or new assets not currently in the building or central plant (e.g., new assets the user is considering purchasing). For example, if the user is considering adding thermal energy storage or electrical energy storage to a building or central plant, the user may select “thermal energy storage” or “battery” from a list of potential assets to size/evaluate. User interface generator 1006 can identify any assets selected via the user interface and provide an indication of the selected assets to asset cost term generator 1008.

Asset cost term generator 1008 can be configured to generate one or more cost terms representing the purchase costs of the assets being sized. In some embodiments, asset cost term generator 1008 generates the following two asset cost terms:

c_{f}^{T}v+cₛ^{T}sₐ

where c_{f} is a vector of fixed costs of buying any size of asset (e.g., one element for each potential asset purchase), v is a vector of binary decision variables that indicate whether the corresponding assets are purchased, cₛ is a vector of marginal costs per unit of asset size (e.g., cost per unit loading, cost per unit capacity), and sₐ is a vector of continuous decision variables corresponding to the asset sizes. Advantageously, the binary purchase decisions in vector v and asset size decisions in vector sₐ can be treated as decision variables to be optimized along with other decision variables x in the augmented cost function Jₐ(x), described in greater detail below.

It should be noted that the values of the binary decision variables in vector v and the continuous decision variables in vector sₐ indicate potential asset purchases and asset sizes which can be evaluated by asset sizing module 916 to determine whether such purchases/sizes optimize a given financial metric. The values of these decision variables can be adjusted by asset sizing module 916 as part of an optimization process and do not necessarily reflect actual purchases or a current set of assets installed in a building, set of buildings, or central plant. Throughout this disclosure, asset sizing module 916 is described as “purchasing” various assets or asset sizes. However, it should be understood that these purchases are merely hypothetical. For example, asset sizing module 916 can “purchase” an asset by setting the binary decision variable vⱼ for the asset to a value of vⱼ=1. This indicates that the asset is considered purchased within a particular hypothetical scenario and the cost of the asset is included in the augmented cost function Jₐ(x). Similarly, asset sizing module 916 can choose to not purchase an asset by setting the binary decision variable vⱼ for the asset to a value of vⱼ=0. This indicates that the asset is considered not purchased within a particular hypothetical scenario and the cost of the asset is not included in the augmented cost function Jₐ(x).

The additional cost terms c_{f}^{T}v and cₛ^{T}sₐ can be used to account for the purchase costs of any number of new assets. For example, if only a single asset is being sized, the vector c_{f} may include a single fixed cost (i.e., the fixed cost of buying any size of the asset being considered) and v may include a single binary decision variable indicating whether the asset is purchased or not purchased (i.e., whether the fixed cost is incurred). The vector cₛ may include a single marginal cost element and sₐ may include a single continuous decision variable indicating the size of the asset to purchase. If the asset has both a maximum loading and a maximum capacity (i.e., the asset is a storage asset), the vector cₛ may include a first marginal cost per unit loading and a second marginal cost per unit capacity. Similarly, the vector sₐ may include a first continuous decision variable indicating the maximum loading size to purchase and a second continuous decision variable indicating the maximum capacity size to purchase.

If multiple assets are being sized, the vectors c_{f}, v, cₛ, and sₐ may include elements for each asset. For example, the vector c_{f} may include a fixed purchase cost for each asset being sized and v may include a binary decision variable indicating whether each asset is purchased. The vector cₛ may include a marginal cost element for each asset being considered and sₐ may include a continuous decision variable indicating the size of each asset to purchase. For any asset that has both a maximum loading and a maximum capacity, the vector cₛ may include multiple marginal cost elements (e.g., a marginal cost per unit loading size and a marginal cost per unit capacity size) and the vector sₐ may include multiple continuous decision variables (e.g., a maximum loading size to purchase and a maximum capacity size to purchase). By accounting for the purchase costs of multiple assets in terms of their respective sizes, the cost terms c_{f}^{T}v and cₛ^{T}sₐ allow high level optimizer 932 to optimize multiple asset sizes concurrently.

Still referring to FIG. 10, asset sizing module 916 is shown to include a constraints generator 1010. Constraints generator 1010 can be configured to generate or update the constraints on the optimization problem. As discussed above, the constraints prevent high level optimizer 932 from allocating a load to an asset that exceeds the asset's maximum loading. For example, the constraints may prevent high level optimizer 932 from allocating a cooling load to a chiller that exceeds the chiller's maximum cooling load or assigning a power setpoint to a battery that exceeds the battery's maximum charge/discharge rate. The constraints may also prevent high level optimizer 932 from allocating resources in a way that causes a storage asset to exceed its maximum capacity or deplete below its minimum capacity. For example, the constraints may prevent high level optimizer 932 from charging a battery or thermal energy storage tank above its maximum capacity or discharging below its minimum stored electric energy (e.g., below zero).

When asset sizes are fixed, the loading constraints can be written as follows:

$${x}_{j , i , load} \leq {x}_{j , {load}_{max}} \begin{matrix}∀ j = 1 … {N}_{a} \\ ∀ i = k … k + h - 1\end{matrix}$$

where x_{j,i,load} is the load on asset j at time step i over the horizon, x_{j,load}_{ₘₐₓ} is the fixed maximum load of the asset j, and Nₐ is the total number of assets. Similarly, the capacity constraints can be written as follows:

$$0 \leq {x}_{j , i , cap} \leq {x}_{j , {cap}_{max}} \begin{matrix}∀ j = 1 … {N}_{a} \\ ∀ i = k … k + h - 1\end{matrix}$$

where x_{j,i,cap} is the capacity of asset j at time step i over the horizon and x_{j,cap}_{ₘₐₓ} is the fixed maximum capacity of the asset j. However, these constraints assume that the maximum load x_{j,load}_{ₘₐₓ} and maximum capacity x_{j,cap}_{ₘₐₓ} of an asset is fixed. When asset sizes are treated as optimization variables, the maximum load and capacity of an asset may be a function of the asset size purchased in the optimization problem (i.e., the size of the asset defined by the values of the binary and continuous decision variables in vectors v and sₐ).

Constraints generator 1010 can be configured to update the loading constraints to accommodate a variable maximum loading for each asset being sized. In some embodiments, constraints generator 1010 updates the loading constraints to limit the maximum load of an asset to be less than or equal to the total size of the asset purchased in the optimization problem. For example, constraints generator 1010 can translate the loading constraints into the following:

$$\begin{matrix}{x}_{j , i , load} \leq {s}_{{a}_{j , load}} \\ {s}_{{a}_{j , load}} \leq {M}_{j} {v}_{j}\end{matrix} ∀ j = 1 … {N}_{a}$$

where sₐ_{_{j,load}} is the loading size of asset j (i.e., the jth load size element of the continuous variable vector sₐ), vⱼ is the binary decision variable indicating whether asset j is purchased (i.e., the jth element of the binary variable vector v), and Mⱼ is a sufficiently large number. In some embodiments, the number Mⱼ is set to the largest size of asset j that can be purchased. The first inequality in this set of constraints ensures that the load on an asset x_{j,i,load} is not greater than the size of the asset sₐ_{_{j,load}} that is purchased. The second inequality forces the optimization to pay for the fixed cost of an asset before increasing the load size of the asset. In other words, asset j must be purchased (i.e., vⱼ=1) before the load size sₐ_{_{j,load}} of asset j can be increased to a non-zero value.

Similarly, constraints generator 1010 can be configured to update the capacity constraints to accommodate a variable maximum capacity for each storage asset being sized. In some embodiments, constraints generator 1010 updates the capacity constraints to limit the capacity of an asset between zero and the total capacity of the asset purchased in the optimization problem. For example, constraints generator 1010 can translate the capacity constraints into the following:

$$\begin{matrix}0 \leq {x}_{j , i , cap} \leq {s}_{{a}_{j} , cap} \\ {s}_{{a}_{j , cap}} \leq {M}_{j} {v}_{j}\end{matrix} ∀ j = 1 … {N}_{a}$$

where sₐ_{_{j,cap}} is the capacity size of asset j (i.e., the jth capacity size element of the continuous variable vector sₐ), vⱼ is the binary decision variable indicating whether asset j is purchased (i.e., the jth element of the binary variable vector v), and Mⱼ is a sufficiently large number. In some embodiments, the number Mⱼ is set to the largest size of asset j that can be purchased. The first inequality in this set of constraints ensures that the capacity of an asset x_{j,i,cap} at any time step i is between zero and the capacity size of the asset sₐ_{_{j,cap}} that is purchased. The second inequality forces the optimization to pay for the fixed cost of an asset before increasing the capacity size of the asset. In other words, asset j must be purchased (i.e., vⱼ=1) before the capacity size sₐ_{_{j,cap}} of asset j can be increased to a non-zero value.

The constraints generated or updated by constraints generator 1010 may be imposed on the optimization problem along with the other constraints generated by high level optimizer 932. In some embodiments, the loading constraints generated by constraints generator 1010 replace the power constraints generated by power constraints module 904. Similarly, the capacity constraints generated by constraints generator 1010 may replace the capacity constraints generated by capacity constraints module 906. However, the asset loading constraints and capacity constraints generated by constraints generator 1010 may be imposed in combination with the switching constraints generated by switching constraints module 908, the demand charge constraints generated by demand charge module 910, and any other constraints imposed by high level optimizer 932.

Still referring to FIG. 10, asset sizing module 916 is shown to include a scaling factor generator 1012. The cost of purchasing an asset is typically paid over the duration of a payback period, referred to herein as a simple payback period (SPP). However, the original cost function J(x) may only capture operational costs and benefits over the optimization period h, which is often much shorter than the SPP. In order to combine the asset purchase costs c_{f}^{T}v and cₛ^{T}sₐ with the original cost function J(x), it may be necessary to place the costs on the same time scale.

In some embodiments, scaling factor generator 1012 generates a scaling factor for the asset cost terms c_{f}^{T}v and cₛ^{T}sₐ. The scaling factor can be used to scale the asset purchase costs c_{f}^{T}v and cₛ^{T}sₐ to the duration of the optimization period h. For example, scaling factor generator 1012 can multiply the terms c_{f}^{T}v and cₛ^{T}sₐ by the ratio

$$\frac{h}{SPP}$$

as shown in the following equation:

$${C}_{scaled} = \frac{h}{8760 \cdot SPP} ( {c}_{f}^{T} v + {c}_{s}^{T} {s}_{a} )$$

where C_{scaled} is the purchase cost of the assets scaled to the optimization period, h is the duration of the optimization period in hours, SPP is the duration of the payback period in years, and 8760 is the number of hours in a year.

In other embodiments, scaling factor generator 1012 generates a scaling factor for the original cost function J(x). The scaling factor can be used to extrapolate the original cost function J(x) to the duration of the simple payback period SPP. For example, scaling factor generator 1012 can multiply the original cost function J(x) by the ratio

$$\frac{SPP}{h}$$

as shown in the following equation:

$${J ( x )}_{scaled} = \frac{8760 \cdot SPP}{hJ ( x )}$$

where J(x)_{scaled} is the scaled cost function extrapolated to the duration of the simple payback period SPP, h is the duration of the optimization period in hours, SPP is the duration of the payback period in years, and 8760 is the number of hours in a year.

Still referring to FIG. 10, asset sizing module 916 is shown to include a cost function augmenter 1014. Cost function augmenter 1014 can be configured to augment the original cost function J(x) with the scaled purchase cost of the assets C_{scaled}. The result is an augmented cost function Jₐ(x) as shown in the following equation:

$${J}_{a} ( x ) = J ( x ) + \frac{h}{8760 \cdot SPP} ( {c}_{f}^{T} v + {c}_{s}^{T} {s}_{a} )$$

where h is the duration of the optimization period in hours, SPP is the duration of the payback period in years, and 8760 is the number of hours in a year.

High level optimizer 932 can perform an optimization process to determine the optimal values of each of the binary decision variables in the vector v and each of the continuous decision variables in the vector sₐ. In some embodiments, high level optimizer 932 uses linear programming (LP) or mixed integer linear programming (MILP) to optimize a financial metric such as net present value (NPV), simple payback period (SPP), or internal rate of return (IRR). Each element of the vectors c_{f}, v, cₛ, and sₐ may correspond to a particular asset and/or a particular asset size. Accordingly, high level optimizer 932 can determine the optimal assets to purchase and the optimal sizes to purchase by identifying the optimal values of the binary decision variables in the vector v and the continuous decision variables in the vector sₐ.

Still referring to FIG. 10, asset sizing module 916 is shown to include a benefit curve generator 1016. Benefit curve generator 1016 can be configured to generate a benefit curve based on the augmented cost function Jₐ(x). In some embodiments, the benefit curve indicates the relationship between the initial investment cost C₀ of an asset (i.e., the cost of purchasing the asset) and the annual benefit C derived from the asset. For example, the benefit curve may express the initial investment cost C₀ as a function of the annual benefit C, as shown in the following equation:

C₀=f(C)

where both the initial investment cost C₀ and the annual benefit C are functions of the asset size. Several examples of benefit curves which can be generated by benefit curve generator 1016 are shown in FIGS. 12-15 (discussed in greater detail below).

In some embodiments, the initial investment cost C₀ is the term C_{f}^{T}v+Cₛ^{T}sₐ in the augmented cost function Jₐ(x). The benefit of an asset over the optimization horizon h may correspond to the term J(x) in the augmented cost function Jₐ(x) and may be represented by the variable Cₕ. In some embodiments, the variable Cₕ represents the difference between a first value of J(x) when the asset is not included in the optimization and a second value of J(x) when the asset is included in the optimization. The annual benefit C can be found by extrapolating the benefit over the horizon Cₕ to a full year. For example, the benefit over the horizon Cₕ can be scaled to a full year as shown in the following equation:

$$C = \frac{8760}{h} {C}_{h}$$

where h is the duration of the optimization horizon in hours and 8760 is the number of hours in a year.

Increasing the size of an asset increases both its initial cost C₀ and the annual benefit C derived from the asset. However, the benefit C of an asset will diminish beyond a certain asset size or initial asset cost C₀. In other words, choosing an asset with a larger size will not yield any increased benefit. The benefit curve indicates the relationship between C₀ and C and can be used to find the asset size that optimizes a given financial metric (e.g., SPP, NPV, IRR, etc.). Several examples of such an optimization are described in detail below. In some embodiments, benefit curve generator 1016 provides the benefit curve to financial metric optimizer 1020 for use in optimizing a financial metric.

Still referring to FIG. 10, asset sizing module 916 is shown to include a financial metric optimizer 1020. Financial metric optimizer 1020 can be configured to find an asset size that optimizes a given financial metric. The financial metric may be net present value (NPV), internal rate of return (IRR), simple payback period (SPP), or any other financial metric which can be optimized as a function of asset size. In some embodiments, the financial metric to be optimized is selected by a user. For example, the user interface generated by user interface generator 1006 may prompt the user to select the financial metric to be optimized. In other embodiments, asset sizing module 916 may automatically determine the financial metric to be optimized or may optimize multiple financial metrics concurrently (e.g., running parallel optimization processes).

### Sustainable Infrastructure Prioritization

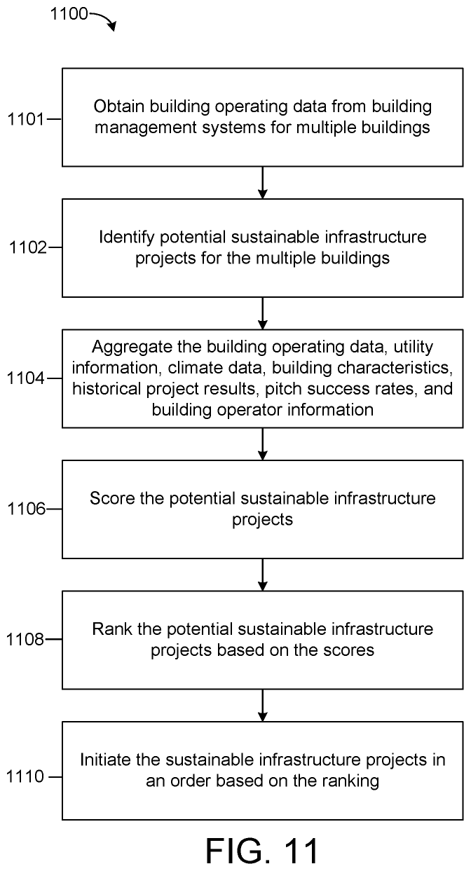

Referring now to FIG. 11, a flowchart of a process 1100 relating to prioritizing and implementing sustainable infrastructure projects for buildings is shown, according to some embodiments. Process 1100 can be executed by any of the various controllers, systems, circuitry, etc., for example by one or more processors executing instructions stored on non-transitory computer-readable media.

Energy and other resource consumption by building infrastructure (e.g., for heating, cooling, ventilating, lighting, etc. building spaces, for powering appliances, computers, etc. in buildings) accounts for a large percentage of total energy and resource usage by society. Providing buildings with sustainable infrastructure (e.g., on-site green energy generation, microgrids, energy storage, improved materials, optimization technologies, etc.) can help reduce overall energy and resource consumption, reach net zero emissions targets, achieve net zero energy goals, combat climate change, reduce or eliminate dependence on fossil fuels, etc. However, installing sustainable infrastructure can be unequally beneficial for different buildings depending on a variety of factors and the ability to install sustainable infrastructure is limited by a number of physical, technical, and other constraints. Process 1100 relates to prioritizing execution of sustainable infrastructure project for buildings in a manner that, for example, can maximize the technical benefits of reduced energy and resource consumption for collections of buildings, achieve emissions reductions in a high-efficiency (e.g., fastest, most cost-effective, etc.) manner, or otherwise unlock the benefits of sustainable infrastructure in an efficient way.

At step 1101, building operating data from building management systems for multiple buildings is obtained. The building operating data can include sensor measurements of conditions in or outside buildings (e.g., temperature, humidity, pressure, air quality, air flow), meter data (e.g., energy usage data, natural gas usage data, water usage data), settings (e.g., temperature setpoints), and other variables. The building operating data can also identify the devices, equipment, etc. operating to serve different buildings. The building operating data may include fault information, maintenance information, building schedules, utilization information, etc. The building operating data may be indicative of building performance and can include data for buildings with sustainable infrastructure already installed (e.g., representing performance of a building with on-site green energy generation, etc.) and buildings without such technologies.

At step 1102, potential sustainable infrastructure projects for multiple buildings are identified. The sustainable infrastructure projects can include, for example, installation of on-site energy storage (e.g., batteries, hot water storage, cold water storage), on-site green energy production system (e.g., photovoltaic system, wind turbine, geothermal), other on-site energy generator (e.g., natural gas, hydrogen fuel cell, nuclear micro-reactor), higher-efficiency lighting devices, higher-efficiency HVAC equipment, building automation system devices and controllers that enable advanced control, and/or various other devices, equipment, services, etc. that can reduce or shift energy consumption of a building.

In some embodiments, step 1102 includes receiving a list of buildings and automatically determining types of projects that would be possible for each of the buildings. In some embodiments, the buildings for which projects are to be considered are buildings for which operating data is obtained in step 1101. In some embodiments, the operating data and/or data on building characteristics (e.g., building age, building dimensions, building materials, existing equipment of a building, etc.) can be used in some embodiments of step 1102 to automatically generate a list of potential sustainable infrastructure projects possible for such buildings. As another example, the set of potential sustainable infrastructure projects can include each of multiple project types for each of the listed buildings. As another example, the set of potential sustainable infrastructure projects includes a one project for each listed building. In some embodiments, step 1102 includes prompting a user for a list of potential sustainable infrastructure projects (e.g., for multiple buildings) and receiving such a list from the user. In some embodiments, step 1102 may include obtaining the list of potential sustainable infrastructure projects from a customer management tool, a sales tool, a construction or building maintenance project management tool, etc.

At step 1104, various data relating to the sustainable infrastructure projects is aggregated, for example with the building operating data. The data can include utility information (e.g., utility rates, marginal emission rates associated with energy produced for an electrical grid, incentive programs, frequency response programs, demand charges, energy buy-back rates), climate data (e.g., temperatures, average cloud cover, average hours of sunlight), building characteristics (e.g., age, dimensions, existing equipment, materials, type, utilization, address), historical project results (e.g., savings of energy, emissions, utility costs, etc. resulting from previous sustainable infrastructure projects, costs of such projects, time to complete such projects), pitch success rates for sustainable infrastructure projects (e.g., from a client relationship management tool), building owner information (e.g., business profiles, recent retrofit activity, recent construction activity, preferences). Data can be aggregated from public (e.g., government) sources (e.g., U.S. Energy Information Administration, Department of Energy, National Oceanic and Atmospheric Administration, National Weather Service, EnergyPlus), utility companies, client relationship management software/databases, building management systems (e.g., Metasys® by Johnson Controls, OpenBlue Enterprise Manager by Johnson Controls), satellite images, and/or other sources. Building operating data can contribute to improving the granularity and robustness of process 1100, for example enabling adaptations of the concepts described above with reference to FIGS. 1-10. In some embodiments, building operating data is omitted, allowing execution of process 1100 without access to building operating data and/or for buildings without existing building management systems (e.g., without step 1101), which can allow the concepts herein to be extended to a larger portfolio of buildings.

At step 1106, the potential sustainable infrastructure projects are scored (e.g., valued, rated, graded, awarded points). Scoring in step 1106 can provide a value (e.g., number, letter grade) for each potential sustainable infrastructure project that represents an overall assessment of the feasibility and benefits of the potential sustainable infrastruction project. Projects which provide the highest benefits at the lowest costs and at the highest rates of success may have the best (e.g., highest) scores, whereas projects with lower benefits, higher costs, and/or more risks may have worse (e.g., lower) scores. Scoring in step 1106 is based on some or all of the data aggregated in step 1104.

In some embodiments, step 1106 includes assessing potential savings based on utility rate information. Because higher utility rates (e.g., price per unit for electricity, natural gas, water, etc., demand charges) indicates more savings for each unit of reduced or time-shifted consumption, step 1106 can include improving (e.g., increasing) a score for a first project for a first building subject to first, higher utility rates relative to a score for a second project for a second building subject to second, lower utility rates. Such scoring can be further influenced by a typical (e.g., baseline, average) demand for the corresponding building, for example as indicated in the building operating data from step 1101.

In some embodiments, step 1106 includes assessing potential emission reductions based on utility information, in particular information indicating emissions rates associated with grid sources of energy. For example, a marginal operating emission rate may be provided by a utility company (or otherwise estimated) and represents the emissions per unit of marginal electricity provided to a building (i.e., emissions from a plant providing electricity to the grid). Because higher grid emission rates indicate more savings for each unit of reduced or time-shifted consumption, step 1106 can include improving (e.g., increasing) a score for a first project for a first building subject to first, higher grid emission rate relative to a score for a second project for a second building subject to second, lower grid emissions rate. Such scoring can be further influenced by a typical (e.g., baseline, average) demand for the corresponding building, for example as indicated in the building operating data from step 1101.

In some embodiments, step 1106 includes assessing rebate, sell-back, and incentive availability for each building and/or each potential project. For different geographies, different utility companies, etc., different benefits may be available for installation and operation of sustainable infrastructure such as green energy production systems and energy storage systems. For example, in scenarios where more green energy is produced (e.g., by a photovoltaic system) at a building than the building is using or storing, utility companies may pay for such electricity to be provided back to the grid at different prices (referred to as buy-back rates) which can vary significantly by geography, utility company, etc. As another example, various incentive-based demand response programs and frequency regulation programs are provided by different utility companies and can increase the value to a building owner of having sustainable building infrastructure that can allow participation in such programs (and thus receipt of such incentives). As another example, various tax credits, reductions, deductions or other grants, discounts, etc. may be available in some locations (some countries, some states, some cities, etc.) for installation of sustainable building infrastructure. Step 1106 can include assessing whether such programs are available and the potential value of such programs that can be unlocked by execution of each potential sustainable infrastructure project, such that the scoring in step 1106 reflects the available value. For example, a score may be better (e.g., higher) for a building with available incentive programs and rebates and/or a higher buy-back rate as compared to a building with less or no available incentive programs and rebates and/or a lower buy-back rate.

In some embodiments, step 1106 includes performing an advanced assessment of compatibility between environmental conditions, utility costs/programs/etc., and building characteristics to influence the scoring. In some embodiments, a neural network or other machine-learning algorithm can be trained to classify (or otherwise rate) sets of environmental conditions, building characteristics, and/or other data as being feasible or unfeasible for certain types of projects, for example, whether determining whether a building has enough of a sun-exposed area for installation of a photovoltaic system that will produce a sufficient amount of energy given climate conditions (e.g., average cloud cover) for a corresponding location. Step 1106 can include various such features for generating scores based on synergies, comparisons, conflicts, etc. between different considerations for a building site. For example, building characteristics (e.g., age, dimensions, existing equipment) may define constraints on selection of feasible project size, equipment types, etc. Building demand, utilization, etc. can also be considered in step 1106. As one example, step 1106 can include identifying any risks or challenges associated with project implementation, for example decreasing a score based on building age to represent the risk of unforeseen challenges during installation/retrofit. Scoring can use the various features described above for asset sizing, planning optimization, buildings operations, etc. to optimally scope projects and predict benefits.

In some embodiments, step 1106 includes affecting the scores for potential projects based on pitch success rate and building operating information including client relationship management information. Scores may be higher for types of projects which were successfully pitched to clients (e.g., building owners) by an entity implementing sustainable infrastructure projects, i.e., reflecting that such projects may be more desirable, more likely to be approved, more likely to succeed, etc. such that the associated efficiencies and technical benefits are more likely to be actualized. Scores may also be higher for building owners and other decision-makers with a record of prior investment in and execution of sustainable building infrastructure projects, as such information reflects the likelihood that projects will be fully implemented (e.g., without disputes, delays, etc.) to provide the full potential technical benefits of such projects.

In some embodiments, step 1106 includes scoring the projects based on assessment of similar buildings based on age, location, building type, building area, etc. for which sustainable infrastructure projects have been executed. A neural network or other machine learning classifier can be used to group/classify projects based on such inputs, for example. Historical project data can be used to identify expected savings in energy usage, emissions, etc. and/or expected project costs, including on a per-unit-area basis, which can be used to provide the scores in step 1106. Any of combination of these or other types of assessments can be used for the scoring of potential infrastructure projects in step 1106.

In step 1108, the potential sustainable infrastructure projects are ranked based on the scores (e.g., from best score to worst score). In some embodiments, step 1108 includes displaying the potential infrastructure projects to a user in a ranked list via a graphical user interface (e.g., via a cloud-hosted webpage accessible via a web browser). In some embodiments, ranking the projects in step 1108 can including allowing a user to filter the projects (e.g., by geographic region, by project type, by project size, by building type, by building owner, etc.) and updating the ranking to display projects satisfying the filter. In some embodiments, the ranked list can display estimated project costs, estimated savings opportunities (in amounts of energy, emissions, money, etc.), payback or breakeven periods, etc., for example quantified on a per-unit-building-area basis. The ranked list can also display success rates from historical data based on projects using similar technologies (e.g., rates indicating the extent to which actual savings exceed, meet, or underperform projected savings).

At step 1110, the sustainable infrastructure projects are initiated in an order based on the ranking. In some embodiments, step 1110 can include ordering parts, equipment, etc. and executing the project by retrofitting a building with new equipment, installing equipment in a new building, or otherwise physically modifying a building. In some embodiments, step 1110 can include scheduling personnel and equipment resources in an order based on the ranking, e.g., given limited engineering resources, skilled labor, tools, heavy machinery, etc. of a team executing the projects and/or given a rate at which new sustainable infrastructure equipment (e.g., solar panels, energy storage devices, etc.) can be produced and shipped, such that the highest scored projects (representing the most potential energy/emissions/etc. savings in various embodiments) can be implemented first given limited resources for executing such projects. In some embodiments, step 1110 can include prioritizing sales calls, pitches, etc. to be carried out in an order indicated by the ranking.

Initiating the sustainable infrastructure projects in an order based on the ranking and scoring of steps 1106-1108 enables sustainable infrastructure to be installed and brought online in an order that reaches maximum benefits in the shortest time. Across a portfolio of buildings and a large set of potential projects, such a prioritization can greatly reduce total energy savings and emission savings over the long term as compared to a scenario where infrastructure projects are implemented in an ad hoc or random order, as the greatest benefits are captured at an earlier time (such that savings are realized both sooner and for longer). Higher efficiency building portfolios can thus be provided by process 1100.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for increasing sustainability of buildings, comprising:
obtaining building operational data from a plurality of building management systems;
providing scores for a plurality of potential sustainable infrastructure projects by scoring the potential sustainable infrastructure projects based on at least one of utility information, climate data, building characteristics, or the building operational data, wherein the scores are generated at least in part on the building operational data;
providing, via a graphical user interface, a ranking of the potential sustainable infrastructure projects based on the scores.

2. The method of claim 1, further comprising executing a subset of the sustainable infrastructure projects in an order based on the ranking.

3. The method of claim 1, wherein:
the plurality of potential sustainable infrastructure projects comprise a first project for a first building and a second project for a second building;
the utility data comprises a first utility rate for the first building and a second utility rate for the second building; and
scoring the potential sustainable infrastructure projects comprises improving a first score for the first project relative to a second score for the second project if the first utility rate is higher than the second utility rate.

4. The method of claim 1, wherein:
the plurality of potential sustainable infrastructure projects comprise a first project for a first building and a second project for a second building;
the utility data comprises a first grid emissions rate associated with energy generated for provision to the first building and a second grid emissions rate associated with energy generated for provision to the second building; and
scoring the potential sustainable infrastructure projects comprises improving a first score for the first project relative to a second score for the second project if the first grid emissions rate is higher than the second grid emissions rate.

5. The method of claim 1, wherein the utility data indicates one or more of incentive program information, demand response program information, frequency regulation program information, demand charge information, and energy buy-back rates.

6. The method of claim 1, wherein the scoring is further based on historical pitch success rates for infrastructure projects.

7. The method of claim 1, wherein the scoring further comprises accounting for retrofit constraints indicated by the building characteristics.

8. The method of claim 1, wherein the scoring further comprises comparing the utility information, the climate data, and the building characteristics.

9. The method of claim 1, wherein the building data comprises building type, building age, and equipment types present.

10. The method of claim 1, comprising predicting savings expected to result from the plurality of potential sustainable infrastructure projects.

11. The method of claim 1, wherein the scoring further comprises determining prices for the plurality of potential sustainable infrastructure projects.

12. One or more non-transitory computer-readable media storing program instructions that, when executed by one or more processors, perform operations comprising:
obtaining building operational data from a plurality of building management systems;
providing scores for a plurality of potential sustainable infrastructure projects by scoring the potential sustainable infrastructure projects based on at least one of utility information, climate data, building characteristics, or the building operational data, wherein the scores are generated at least in part on the building operational data;
providing, via a graphical user interface, a ranking of the potential sustainable infrastructure projects based on the scores.

13. The one or more non-transitory computer-readable media of claim 12, wherein the operations further comprise initiating the sustainable infrastructure projects in an order based on the ranking.

14. The one or more non-transitory computer-readable media of claim 12, wherein:
the plurality of potential sustainable infrastructure projects comprise a first project for a first building and a second project for a second building;
the utility data comprises a first utility rate for the first building and a second utility rate for the second building; and
scoring the potential sustainable infrastructure projects comprises improving a first score for the first project relative to a second score for the second project if the first utility rate is higher than the second utility rate.

15. The one or more non-transitory computer-readable media of claim 12, wherein:
the plurality of potential sustainable infrastructure projects comprise a first project for a first building and a second project for a second building;
the utility data comprises a first grid emissions rate associated with energy generated for provision to the first building and a second grid emissions rate associated with energy generated for provision to the second building; and
scoring the potential sustainable infrastructure projects comprises improving a first score for the first project relative to a second score for the second project if the first grid emissions rate is higher than the second grid emissions rate.

16. The one or more non-transitory computer-readable media of claim 12, wherein the score further comprises accounting for retrofit constraints indicated by the building characteristics and comparing the utility information, the climate data, and the building characteristics.

17. The one or more non-transitory computer-readable media of claim 12, the operations further predicting savings expected to result from the plurality of potential sustainable infrastructure projects, determining prices for the plurality of potential sustainable infrastructure projects, and comparing the savings with the prices.

18. A method of executing sustainable infrastructure projects, comprising:
ranking the sustainable infrastructure projects by scoring the sustainable infrastructure projects based on utility information, climate data, building characteristics, and building operational data associated with the sustainable infrastructure projects; and
installing building equipment or modifying at least one building to execute the sustainable infrastructure projects in an order indicated by the ranking.

19. The method of claim 18, wherein:
the sustainable infrastructure projects comprise a first project for a first building and a second project for a second building;
the utility data comprises a first grid emissions rate associated with energy generated for provision to the first building and a second grid emissions rate associated with energy generated for provision to the second building; and
scoring the sustainable infrastructure projects comprises improving a first score for the first project relative to a second score for the second project if the first grid emissions rate is higher than the second grid emissions rate.

20. The method of claim 18, wherein scoring the sustainable infrastructure projects is based on retrofit constraints indicated by the building characteristics or the building operational data.
